(19) United States
(12) Patent Application Publication
(10) Pub. No.: US 2020/0079064 A1
(43) Pub. Date: Mar. 12, 2020

(54) HEAT-SEALABLE POLYESTER FILM FOR PRODUCTION OF READY-MEAL TRAYS, PROCESS FOR ITS PRODUCTION, AND USE OF THE FILM

(71) Applicant: Mitsubishi Polyester Film GmbH, Wiesbaden (DE)

(72) Inventors: Herbert PEIFFER, Mainz (DE); Martin JESBERGER, Mainz (DE); Bodo KUHMANN, Runkel (DE); Viktor FISCHER, Oftersheim (DE); Tobias RENTZSCH, Bad Homburg (DE)

(21) Appl. No.: 16/565,900

(22) Filed: Sep. 10, 2019

(30) Foreign Application Priority Data
Sep. 11, 2018 (DE) 10 2018 215 422.8

(51) Int. Cl. B32B 27/36; B32B 27/08; B32B 37/15; B65D 1/34; B32B 1/02

(52) U.S. Cl. CPC B32B 27/36; B32B 27/08; B32B 37/15; B65D 1/34; B32B 1/02; B32B 2439/02; B32B 2270/00; B32B 2367/00; B32B 2439/70; B32B 2250/244; B32B 2250/03; B32B 2307/31

(57) ABSTRACT

Coextruded, unstructured, transparent and thermoformable polyester films are provided including at least one base layer (B) made of a-PET and one heat-sealable outer layer (A). The heat-sealable outer layer (A) includes at least 80% by weight of polyester with from 25 to 95 mol % of units derived from at least one aromatic dicarboxylic acid and 5 to 75 mol % of units derived from at least one aliphatic dicarboxylic acid, along with aliphatic diols. The outer layer (A) also includes up to 0.4% by weight of inorganic or organic particles with median diameter d₅₀ 2.0 to 8.0 μm. The thickness of the outer layer (A) is 10 to 100 μm, and the thickness of the film is in the range 100 to 1500 μm. The invention further relates to processes for producing the inventive film, and also to packaging for foods or other consumable products, such as trays.

### CROSS-REFERENCE TO RELATED APPLICATIONS

This application claims priority to German Patent Application No. 10 2018 215 422.8 filed Sep. 11, 2018, which is hereby incorporated herein by reference in its entirety.

### FIELD OF THE INVENTION

The invention relates to a coextruded and unstructured, transparent and thermoformable polyester film with a heat-sealable layer for the production of trays. The thermoformable and heat-sealable polyester film serves—after it has been thermoformed to give a tray—to receive food, e.g. fish, poultry or fresh meat. The invention further relates to a process for the production of the film and to use of the film.

### BACKGROUND OF THE INVENTION

Transparent trays made of thermoformable, amorphous polyethylene terephthalate (a-PET) are produced in the food industry by way of example with use of vacuum processes. After the food has been placed therein, a lid film is sealed to the edge of the tray and the pack is thus securely closed—in order to protect the food from exterior effects. These packs are used for fish, poultry, precooked meat and fresh meat, and for dry finished products such as sandwiches, burgers or wraps. These packs are considered a method for preparing the products that is clean and hygienic; this method is therefore very widely used.

The processes known as vacuum processes provide a cost-effective method of producing hygienic packs for the processing of meat, fish or poultry. The procedure for producing the finished pack here is generally as follows: the film for producing the trays (also termed lower film) is clamped in the form of roll into the machine. The film is thermoformed by way of vacuum chambers to a desired depth to give a tray with use of heat and vacuum. The food product is placed into the tray manually—or in the case of large numbers of units in essence by use of machines. The lid film (also termed upper film) is introduced by way of another roll to the tray and sealed securely to the edge thereof with use of heat and pressure. The thermoformed trays securely sealed by the lid film, are separated into individual packs, e.g. by punching, and are marketed after further operations such as printing or labelling.

The residual skeletal waste in the production of the trays here makes up up to 50% of the film used to produce the trays. In order to reduce this waste, it is desirable that the skeletal waste can be directly introduced, for example in the form of regrind, into the extrusion procedure for the production of new thermoformable film.

In the development of packs with new and improved properties, it is necessary for performance-related reasons to achieve durable, at least secure heat-sealing between the lid film and the tray containing the food.

Secure heat-sealing is defined in terms of the application as achieved when the sealing force is in the range of about 3 to 10 N per 15 mm of film strip width. The term low-strength heat-sealing is used for values lower than these, and the term high-strength heat-sealing is used for values higher than these.

Secure heat-sealing is in particular desirable in the production of packaging for fresh meat where the product is generally placed into the tray by use of machines. When the food is placed into the tray, it is possible here that the sealing edge of the tray becomes contaminated with small quantities of food substances, for example meat juices. It is essential here that complete heat-sealing of two films is achieved through the area contaminated with meat juices.

This problem has conventionally been solved hitherto by technical means consisting in the use of multilayer plastics films, not only for the thermoformable lower film but also for the sealable upper film or lid film.

If polyester is used for both films, by way of example thermoformable a-PET for the lower film and by way of example biaxially oriented PET for upper film, the respective sealing layer in the multilayer plastics films mentioned is comprised of a type of plastic differing from a-PET.

This different type of plastic is selected to be more fusible at the desired low sealing temperature and, in the molten state, significantly more ductile than a-PET. Typical materials for this purpose are polypropylene (PP), and in particular polyethylene (PE), which has the lowest melting point and is very ductile in the molten state. Both materials, PP and PE, can be applied by lamination, extrusion coating or coextrusion to the polyester base layer.

Packaging in the form of a PET-PE solution where the base layer for the tray and the base layer for the lid film consists of polyester, while sealable layers consist of PE, is known in the market.

A known problem arises when fresh meat is packed in a-PET trays with lids made of polyester. When this combination of materials is used, the finished packaging often exhibits incomplete sealing. The pack is found to be only loosely sealed, to open during transport, or not to be gastight. In the case of packaging with modified atmosphere (MAP), the sealed area is unable to retain the modified atmosphere within the container for the stated shelf life; this leads to accelerated spoiling of the food stored in the container.

The tray made of thermoformable polyester with the lid film likewise made of polyester is heat-sealed at sealing temperatures between 120 and 220° C., or in the case of an “all-polyester solution” typically at 160 to 220° C. The process is cost-effective if the sealing time can be restricted to three seconds or less.

Two different film concepts for the structure of the pack can currently be observed in use alongside one another in the market:
films both completely comprised of polyester polymers, the films here having one or more layers
films comprised of polyester polymers in the “core layers or base layers”, the sealable layers here consisting of polypropylene, and or in particular of polyethylene.

The present invention relates to the solution for a sealable, thermoformable lower film made of polyester polymers that is suitable for heat-sealing through areas contaminated with meat juices or the like.

A thermoformable lower film that is produced from only a single material—in this case polyester—has a number of technical advantages:
waste arising during the production of the films and of the trays, inter alia “skeletal waste”, can easily be recycled
the resultant regrind (recyclate) can be reused in the production of new trays without any resultant sacrifice of quality
the pack is more visually attractive than the pack using the known APET-PE solution
“post-consumer recycling” (PCR) is easier than in the case of an APET-PE solution.

Thermoformable films made of polyester are known for production of trays.

EP 2 643 238 B1 describes a food tray comprised of a single- or multilayer sheet, where the material of each of the layers comprises at least 85% of amorphous polyethylene terephthalate. The tray comprises a base component, side walls and a peripheral sealing lip, where the sealing lip has an upward-facing sealing area that is in essence flat. The sealing area comprises, in addition to the tray material, a layer of an adhesive of the invention over the entire perimeter of the tray. The tray is formed by thermoforming of the sheet, and the adhesive here can be applied to the sealing area by means of roll-coating directly after the procedure for shaping of the tray. The adhesive comprises ethylene co- and terpolymers or a mixture thereof, and also a wax. The container is in particular suitable for sealing where the sealing area of the tray has been contaminated with small quantities of food substances, for example meat juices. The inventive solution requires improvement in several respects: application, to the sealing area, of an additional adhesive layer made of, in essence, polyethylene makes the product more expensive; waste arising during the procedure cannot be reintroduced into extrusion of films for tray production without loss of quality, and post-consumer recycling becomes significantly more difficult.

EP 3 296 227 A1 describes a food tray comprised of a single- or multilayer sheet, where the material of each of the layers comprises at least 85% of amorphous polyethylene terephthalate. The tray comprises a base component, side walls and a peripheral sealing lip, where the sealing lip has an upward-facing sealing area that is in essence flat. At least the tray layer that forms the sealable layer (corresponding to the sealing area) has been modified to have increased softness at relevant sealing temperatures, typically between 120 and 180° C. This layer (or these layers) has/have moreover been modified to reduce its/their surface energy. Improved softness of at least the sealable layer is obtained by using comonomers, such as isophthalic acid (IPA), cyclohexanedimethanol (CHDM) or diethylene glycol (DEG) to modify the polyethylene terephthalate present in the layer, e.g. by coextrusion. The surface energy of the sealable layer is reduced by addition of an internal and/or external lubricant, e.g. a wax. The additive can be introduced internally for example by means of coextrusion into the surface layer, and externally by way of example by means of coating of the surface layer.

The tray is suitable for the application mentioned in the introduction—sealing through contamination—but requires improvement in sealing properties and in optical properties. The application mentions a number of materials/additives that can be used to modify the surface layer of the tray. However, the application contains no specific information about formulations or processes for production of the films, and there is also a lack of information relating to the thickness of the inventive surface layer of the tray. The patent application therefore does not disclose the invention in a manner sufficiently clear and complete to permit its implementation, or repetition, by a person skilled in the art.

### SUMMARY OF ADVANTAGEOUS EMBODIMENTS OF THE INVENTION

It was an object of the present invention to provide, for the application mentioned in the introduction, a coextruded and thermoformable, in essence amorphous, unstructured film which is made of polyester and which features excellent sealing properties. In the event that the sealable layer of the film has been contaminated with small quantities of food substances, for example meat juices, the sealing in relation to commercially obtainable lid films is intended to be sufficiently good to achieve secure sealing. The film is moreover intended to exhibit particularly brilliant optical properties. It is intended to overcome the disadvantages of films of the prior art and in particular to feature the following aspects/properties.
The thermoformable film, suitable for production of trays via thermoforming, is a multilayer film and is in essence comprised of polyester raw materials.
The thermoformable film is intended to feature secure heat-sealing. Sealing—even via contaminated surfaces, for example through meat juices—is intended to give a durably secure seal between the tray and commercially obtainable lid films. Secure heat-sealing is achieved when the sealing force is in the range of about 3 to 10 N per 15 mm of film strip width.
The thermoformable film is intended to feature brilliant optical properties. This relates to the haze, and in particular the clarity, of the film. It is desirable that the haze thereof is below 10%, the clarity thereof is above 80% and the gloss thereof is above 100; (all optical values are measured directly after production of the film).
The thermoformable film is intended to be amenable to cost-effective production. This means by way of example that processes conventional in industry, for example coextrusion processes, can be used to produce the film.
It is moreover desirable that the waste arising during production of the thermoformable film and of the tray (e.g. the skeletal waste) can be reused as regrind with no sacrifice of quality.
It is moreover desirable that the regrind can be reused at up to 50% for the production of films for trays of the type described in the introduction.

### BRIEF DESCRIPTION OF THE DRAWING

FIG. 1 is a schematic illustration of an exemplary tray format.

### DETAILED DESCRIPTION OF ADVANTAGEOUS EMBODIMENTS OF THE INVENTION

The object is achieved via provision of a coextruded and unstructured, transparent and thermoformable polyester film for production of trays, comprising at least one base layer (B) made of a-PET and one heat-sealable outer layer (A), where the heat-sealable outer layer (A) comprises at least 80% by weight of polyester, where
a) the polyester of the outer layer (A) is comprised of 25 to 95 mol % of units derived from at least one aromatic dicarboxylic acid and 5 to 75 mol % of units derived from at least one aliphatic dicarboxylic acid, and is based on aliphatic diols, where the mol % data always give a total of 100%
b) the outer layer (A) comprises up to 0.4% by weight of inorganic or organic particles with median diameter d₅₀ 2.0 to 8.0 μm
c) the thickness of the outer layer (A) is 10 to 100 μm
d) the haze of the film is below 10% and the clarity of the film is at least 80%
e) the seal seam strength of the film in relation to itself (=FIN sealing) is in the range 3 to 10 N/15 mm and
f) the thickness of the film is in the range 100 to 1500 μm.

Unless otherwise mentioned, the expression % by weight above and hereinafter always refers to the weight of the respective layer of the respective system in connection with which the data is specified.

The thermoformable film of the present invention is in essence formed by a coextruded, unoriented, transparent and heat-sealable polyester film (AB) or (ABC). It is comprised of at least two layers. It then consists of the base layer (B) and of the heat-sealable outer layer (A) applied by coextrusion thereon. The outer layer (A) is comprised predominantly, i.e. to an extent of at least 80% by weight, of polyesters.

### Heat-Sealable Outer Layer (A)

### Polymers for the Outer Layer (A)

The heat-sealable outer layer (A) in the invention comprises at least one polyester and optionally an antiblocking agent. The polyester is comprised of units derived from aromatic and aliphatic dicarboxylic acids. The quantity present in the polyester of the units derived from aromatic dicarboxylic acids is 25 to 95 mol %, preferably 40 to 90 mol %, particularly preferably 50 to 88 mol %. The quantity present in the polyester of the units derived from aliphatic dicarboxylic acids is 5 to 75 mol %, preferably 10 to 60 mol %, particularly preferably 12 to 50 mol %, where the mol % data always give a total of 100%. The diol units corresponding thereto likewise always give 100 mol %.

Examples of the aromatic dicarboxylic acids that can be used in the invention are terephthalic acid, isophthalic acid, phthalic acid and naphthalene-2,6-dicarboxylic acid.

Examples of aliphatic dicarboxylic acids are succinic acid, glutaric acid, adipic acid, pimelic acid, suberic acid, azeleic acid and sebacic acid. Acids that can preferably be used in the invention are adipic acid and sebacic acid; acids that can be used with less preference are succinic acid, glutaric acid, adipic acid, pimelic acid, suberic acid and azeleic acid.

Examples of the aliphatic diols that can be used in the invention are ethylene glycol, 1,3-propanediol, 1,3-butanediol, 1,4-butanediol, 1,5-pentanediol, 2,2-dimethyl-1,3-propanediol, diethylene glycol, triethylene glycol, 1,4-cyclohexanedimethanol and neopentyl glycol.

In the preferred embodiment, the polyester includes the following dicarboxylate moieties and alkylene moieties, based in each case on the total quantity of dicarboxylate and, respectively, total quantity of alkylene:
25 to 95 mol %, preferably 30 to 90 mol % and particularly preferably 40 to 70 mol %, of terephthalate,
0 to 25 mol %, preferably 5 to 20 mol % and particularly preferably 10 to 20 mol %, of isophthalate,
5 to 75 mol %, preferably 8 to 70 mol % and particularly preferably 11 to 65 mol %, of sebacate,
0 to 50 mol %, preferably 0 to 40 mol % and particularly preferably 0 to 30 mol %, of adipate,
more than 30 mol %, preferably more than 40 mol % and particularly preferably more than 50 mol %, of ethylene or butylene.

The outer layer material optionally comprises up to 10% by weight of a polymer that is incompatible with polyester (=anti-PET polymer). In a preferred embodiment, the proportion of anti-PET polymer is 1 to 10% by weight and particularly 2 to 9% by weight.

Up to 5% by weight of the material of the outer layer (A) consists of particles, additives, auxiliaries and/or other additional substances usually used in polyester film technology.

The polyester for the outer layer (A) is preferably produced from two physically miscible polyesters I and II and particularly preferably from three physically miscible polyesters I, II and III, which are introduced into the extruder for this layer (A) in the form of mixture.

### Polyester I for the Outer Layer (A)

The proportion in the outer layer (A), of polyester I, which consists of one or more aromatic dicarboxylate moieties and one or more aliphatic alkylene moieties, is 10 to 60% by weight.

In the preferred embodiment, the proportion of polyester I is 15 to 55% by weight, and in the particularly preferred embodiment it is 20 to 50% by weight.

In the preferred embodiment, the polyester I of the outer layer (A) of the invention is based on the following dicarboxylate moieties and alkylene moieties, based in each case on the total quantity of dicarboxylate and, respectively, total quantity of alkylene:
60 to 100 mol %, preferably 62 to 95 mol % and particularly preferably 66 to 93 mol %, of terephthalate
0 to 40 mol %, preferably 5 to 38 mol % and particularly preferably 7 to 34 mol %, of isophthalate, where the mol % data for the dicarboxylic acids mentioned always give a total of 100%
more than 50 mol %, preferably more than 65 mol % and particularly preferably more than 80 mol %, of ethylene units.

Very particular preference is given to copolyesters in which the proportion of terephthalate units is 60 to 80 mol %, the corresponding proportion of isophthalate units is 20 to 40 mol % and the proportion of ethylene units is 100 mol %, these therefore being ethylene terephthalate-ethylene isophthalate copolymers.

Any residual content present derives from other aromatic dicarboxylic acids and from other aliphatic diols as listed as main and suitable other aromatic dicarboxylic acids for the base layer (B).

It has been found that in the event that the proportion of polyester I in the outer layer (A) is below 10% by weight, it becomes significantly more difficult to produce the film by means of coextrusion technology, or becomes impossible to ensure that the film can be thus produced. The film is then highly susceptible to adhesion on certain machine components, in particular on metallic rolls. If, on the other hand, the proportion of polyester I in the outer layer (A) is more than 60% by weight, the sealing behavior of the film for the present application is greatly impaired. As a consequence of the resultant melting point increase, the sealable layer (A) no longer has, at the sealing temperatures usually used, the desired softness required for sealing through the contamination.

The SV value of the raw material in the invention here is above 600, preferably above 650 and particularly preferably above 700. If the SV value of the raw material is below 600, the extrudability of the raw materials becomes poorer; this is undesirable.

### Polyester II for the Outer Layer (A)

In the preferred embodiment of the present invention, the proportion of polyester II in the outer layer (A) is 20 to 70% by weight. In the preferred embodiment, the proportion of polyester II is 25 to 65% by weight, and in the particularly preferred embodiment it is 30 to 60% by weight.

The polyester II preferably consists of a copolymer of aliphatic and aromatic acid components in which the aliphatic acid components provide 20 to 90 mol %, preferably 30 to 70 mol % and particularly preferably 35 to 60 mol %, based on the total quantity of acid in the polyester II. The balance of dicarboxylate content to give 100 mol % derives from the aromatic acids terephthalic acid and isophthalic acid, terephthalic acid being mentioned here with preference and isophthalic acid being mentioned here with less preference, and also, on the glycolic side, from aliphatic, cycloaliphatic or aromatic diols as described in relation to the base layer (B).

The polyester II of the outer layer (A) of the invention is based at least on the following dicarboxylate moieties and alkylene moieties, based in each case on the total quantity of dicarboxylate and, respectively, total quantity of alkylene:
20 to 70 mol %, preferably 30 to 65 mol % and particularly preferably 35 to 60 mol %, of sebacate
0 to 50 mol %, preferably 0 to 45 mol % and particularly preferably 0 to 40 mol %, of adipate
10 to 80 mol %, preferably 20 to 70 mol % and particularly preferably 30 to 60 mol %, of terephthalate
0 to 30 mol %, preferably 3 to 25 mol % and particularly preferably 5 to 20 mol %, of isophthalate, where the mol % data for the dicarboxylic acids mentioned always give a total of 100%
more than 30 mol %, preferably more than 40 mol % and particularly preferably more than 50 mol %, of ethylene or butylene.

In the preferred embodiment, the polyester II of the outer layer (A) of the invention is based at least on the following dicarboxylate moieties and alkylene moieties, based in each case on the total quantity of dicarboxylate and, respectively, total quantity of alkylene:
20 to 70 mol %, preferably 30 to 65 mol % and particularly preferably 35 to 60 mol %, of sebacate
10 to 80 mol %, preferably 20 to 70 mol % and particularly preferably 30 to 60 mol %, of terephthalate
0 to 20 mol %, preferably 3 to 15 mol % and particularly preferably 3 to 10 mol % of isophthalate
more than 30 mol %, preferably more than 40 mol % and particularly preferably more than 50 mol %, of ethylene or butylene.

Any residual content present derives from other aromatic dicarboxylic acids and from other aliphatic diols as listed for the base layer (B).

The presence of at least 10 mol % of aromatic dicarboxylic acid ensures that the polymer II can be processed without sticking for example in the coextruder.

If the proportion of polyester II in the outer layer (A) is less than 20% by weight, the sealing behavior of the film is greatly impaired. As already described above, the sealable layer then no longer has, at the usual sealing temperatures, the desired softness required for good sealing through contamination. If, in contrast, the proportion of polyester II in the outer layer (A) is above 70% by weight, it becomes significantly more difficult to produce the film by means of coextrusion technology, or becomes impossible to ensure that the film can be thus produced. The film here is highly susceptible to adhesion on certain machine components, in particular on metallic rolls.

The SV value of the raw material in the invention here is above 900, preferably above 950 and particularly preferably above 1000. If the SV value of the raw material is below 900, the haze of the film becomes higher; this is undesirable.

### Optional Polyester III for the Outer Layer (A)

The optional proportion in the outer layer (A) of polyester III, which consists of one or more aromatic dicarboxylate moieties and one or more aliphatic alkylene moieties, is 0 to 15% by weight. In the preferred embodiment, the proportion of polyester III in the outer layer (A) is 3 to 12% by weight, and in the particularly preferred embodiment it is 4 to 10% by weight.

The polyester III of the outer layer (A) of the invention is generally based on the following dicarboxylate moieties and alkylene moieties, based in each case on the total quantity of dicarboxylate and, respectively, the total quantity of alkylene:
80 to 98 mol %, preferably 82 to 96 mol % and particularly preferably 74 to 95 mol %, of terephthalate
2 to 20 mol %, preferably 4 to 18 mol % and particularly preferably 5 to 17 mol %, of isophthalate
more than 50 mol %, preferably more than 65 mol % and particularly preferably more than 80 mol %, of ethylene units.

Any residual content present derives from other aromatic dicarboxylic acids and from other aliphatic diols as listed as main and suitable other aromatic dicarboxylic acids for the base layer (B).

In mixing of the polyesters I, II and III, care must be taken that the proportions in % by weight give a total of 100.

Very particular preference is given to copolyesters in which the proportion of terephthalate units is 84 to 94 mol %, the corresponding proportion of isophthalate units is 6 to 16 mol % (where the dicarboxylate content in turn gives a total of 100 mol %), and the proportion of ethylene units is 100 mol %, these therefore being polyethylene terephthalate/isophthalates.

In a particularly preferred embodiment, the polyester III comprises a proportion of 5 to 25% by weight of a suitable antiblocking agent (see further below). In this particularly preferred embodiment, polyester III is a masterbatch which is preferably produced by way of extrusion technology. The concentration at which the antiblocking agent here is added to the polyester raw material during extrusion (preferably in twin-screw extruder) is significantly higher than the concentration subsequently present in the film. The SV value of the masterbatch in the invention here is above 400, preferably above 425 and particularly preferably above 450.

The outer layer (A) preferably comprises a mixture of the polyesters I, II and III. This mixture has the following advantages in comparison with the use of only one polyester with comparable components and comparable proportions of the components:
on the basis of the respective glass transition temperatures (Tg), the mixture of the polyesters I, II and III is easier to extrude than any single raw material with comparable concentration of the respective polymer components. Studies have revealed that a mixture of polymers with high Tg (polyesters I and III) with a polymer with low Tg (polyester II) is less susceptible to sticking in the coextruder than a single polymer with a corresponding average Tg.
in practice, individual adjustment to the desired sealing properties is more satisfactorily achievable with the mixture than when a single polyester is used.
another advantage is that the Tg (in relation to the entire outer layer) can be set more effectively/more easily.
in particular, additions of particles is easier with polyester III than with polyester I or II.

The glass transition temperature of polyester I and III is advantageously above 50° C. The glass transition temperature of polyester I and III is preferably above 55° C. and particularly preferably above 60° C. If the glass transition temperature of polyester I and III is below 50° C., the film cannot be produced in a reliable process. The susceptibility of the outer layer (A) toward adhesion, for example to rolls, is so great here that frequently film break-offs must be considered likely.

The glass transition temperature of polyester II is advantageously below 10° C. The glass transition temperature is preferably below 8° C. and particularly preferably below 6° C. If the glass transition temperature of polyester II is above 10° C., the sealable layer no longer has, at the usual sealing temperatures, the desired softness required for sealing through contamination.

In respect of the polymers for the outer layer (A), it is advantageous in the invention that the Tg of the entire outer layer (A) is in a range below 60° C., preferably below 55° C. and particularly preferably below 50° C. The softness of the outer layer (A) is then particularly high.

### Anti PET-Polymer in the Outer Layer (A)

The heat-sealable outer layer (A) optionally comprises a certain concentration of a polymer (anti-PET polymer) incompatible with polyester. The proportion of the anti-PET polymer is 0 to 10% by weight, based on the weight of the outer layer (A). In a preferred embodiment, the proportion of the anti-PET polymer is 3 to 10% by weight, and in a particularly preferred embodiment it is 5 to 10% by weight, likewise based on the weight of the outer layer (A).

Examples of suitable anti-PET polymers are polymers based on ethylene (LLDPE, HDPE), on propylene (PP), on cycloolefins (CO), or on amides (PA) or styrene (PS). In a preferred embodiment, a copolymer is used as anti-PET polymer. Examples here are copolymers based on ethylene (C2/C3, C2/C3/C4 copolymers), on propylene (C2/C3, C2/C3/C4 copolymers), or on cycloolefins (norbornene/ethylene copolymers, tetracyclododecene/ethylene copolymers). In one of the particularly preferred embodiments, the polymer incompatible with polyester is a cycloolefin copolymer (COC). These cycloolefin copolymers are described by way of example in EP-A 1 068 949, whose United States equivalent is U.S. Pat. No. 6,641,924 that is expressly incorporated herein by reference, or in JP 05-009319.

Among the cycloolefin copolymers (COCs), preference is in particular given to those comprising polymerized units of polycyclic olefins with underlying norbornene structure, particularly preferably norbornene or tetracyclododecene. Particular preference is given to cycloolefin copolymers which comprise polymerized units of acyclic olefins, in particular ethylene. Very particular preference is given to norbornene/ethylene and tetracyclododecene/ethylene copolymers which comprise 5 to 80% by weight of ethylene units, preferably 10 to 60% by weight of ethylene units (based on the weight of the copolymer).

The glass transition temperatures of the COCs are generally between −20 and 400° C. COCs suitable for the invention are those with glass transition temperature below 120° C., preferably below 100° C. and particularly preferably below 80° C. The glass transition temperature should preferably be above 50° C., preferably above 55° C., in particular above 60° C. The viscosity number (Decalin, 135° C., DIN 53 728) is advantageously between 0.1 and 200 ml/g, preferably between 50 and 150 ml/g.

Foils comprising a COC with glass transition temperature below 80° C. feature lower haze and better sealability than those comprising a COC with glass transition temperature above 80° C.

EP-A-0 283 164, EP-A-0 407 870, EP-A-0 485 893 and EP-A-0 503 422 describe the production of COCs with catalysts based on soluble metallocene complexes. Cycloolefin copolymers produced with catalysts based on soluble metallocene complexes are particularly preferred. These COCs are obtainable commercially, an example being TOPAS® (Ticona, Frankfurt).

Additionally anti-PET polymer is advantageous for sealing and for processing behavior, in particular here the winding of the film of the invention. If the proportion of the COC in the preferred embodiment is below 3% by weight, there is no longer any favorable effect of the polymer on the sealing and the processing behavior of the tray. The tray is susceptible to blocking. On the other hand, the proportion of polyester-incompatible polymer should not exceed 10% by weight, because otherwise the haze of the film becomes excessive.

### Antiblocking Agent in the Outer Layer (A)

For further improvement of the processability of the film, it has proven advantageous to carry out further modification of the heat-sealable outer layer (A). This is best achieved with the aid of simple antiblocking agents which are added to the sealable layer in the form of polyester raw material III (in a manner equivalent to antiblocking masterbatch), and specifically in quantities that prevent blocking of the film and optimize the processing behavior of the film.

Food good processability of the film it has proven to be particularly advantageous to use particles with median particle diameter d₅₀ 2.0 to 8.0 μm, preferably 2.5 to 7.5 μm and particularly preferably 3.0 to 7.0 μm. If particles with diameter below 2.0 μm are used, there is no longer any favorable effect of the particles on the processing behavior of the film. The film is susceptible to blocking; this is undesirable. Particles with diameter above 8.0 μm generally cause excessive haze, and also filter problems.

It has moreover proven to be advantageous that the heat-sealable outer layer (A) comprises particles at a concentration up to 0.5% by weight, preferably 0.01 to 0.4% by weight and particularly preferably 0.01 to 0.35% by weight. If the outer layer (A) comprises particles at a concentration above 0.5% by weight, the haze of the film becomes excessive.

Particles preferred in the invention are synthetically produced amorphous SiO₂ particles in colloidal form, which give excellent binding into the polymer matrix. Reference is made to the prior art in relation to the production of the SiO₂ particles; the process is disclosed in detail by way of example in EP 1 475 228 B1.

Typical other particles that can be used in the outer layer (A) are inorganic and/or organic particles, for example calcium carbonate, talc, magnesium carbonate, barium carbonate, calcium sulfate, barium sulfate, lithium phosphate, calcium phosphate, magnesium phosphate, aluminum oxide, LiF, the calcium, barium, zinc or manganese salts of the dicarboxylic acids used, titanium dioxide or kaolin.

### Thickness of the Outer Layer (A)

The thickness of the heat-sealable outer layer (A) in the invention is 10 to 100 μm. If the thickness of the outer layer (A) is below 10 μm, sealing of the film is inadequate. If the thickness of the outer layer is above 100 μm, the film is susceptible to blocking; this is undesirable.

The outer layer (A) exhibits very good sealing properties in relation to itself (FIN sealing, outer layer (A) in relation to outer layer (A)). The seal seam strength of the outer layer (A) in relation to itself (FIN sealing) after heat-sealing at 150° C. (460 N, 2 s) is above 3 N/15 mm and is at most 10 N/15 mm.

It is highly surprising that compliance with the outer-layer formulation of the invention in all cases achieves a durably secure seal, even when the film has been contaminated with meat juices or the like.

### Base Layer (B)

### Polymers Used for the Base Layer (B)

The base layer (B) of the film consists of at least 90% by weight of a thermoplastic polyester which is comprised of dicarboxylic acid-derived units and diol-derived units, or of dicarboxylate moieties and of alkylene moieties, and which generally includes the following dicarboxylate moieties and alkylene moieties, based in each case on the total quantity of dicarboxylate and, respectively, the total quantity of alkylene (=main carboxylic acids):
more than 90 mol %, preferably more than 92 mol %, of terephthalate
less than 10 mol %, preferably less than 8 mol %, of isophthalate or 2,6-naphthalate
more than 90 mol %, preferably more than 95 mol %, of ethylene.

Examples of suitable other aliphatic diols for forming the polyester are diethylene glycol, triethylene glycol, aliphatic glycols of the general formula HO—(CH₂)ₙ—OH, where n is an integer from 3 to 6 (in particular propane-1,3-diol, butane-1,4-diol, pentane-1,5-diol and hexane-1,6-diol) and branched aliphatic diols having up to six carbon atoms. Suitable other aromatic diols correspond by way of example to the formula HO—C₆H₄—X—C₆H₄—OH, where X is —CH₂—, —C(CH₃)₂—, —C(CF₃)₂—, —O—, —S— or —SO₂—.

Other aromatic dicarboxylic acids are preferably benzenedicarboxylic acids, naphthalenedicarboxylic acids, for example naphthalene-1,4- or -1,6-dicarboxylic acid, biphenyl-x,x′-dicarboxylic acids, in particular biphenyl-4,4′-dicarboxylic acid, diphenylacetylene-x,x′-dicarboxylic acids, in particular diphenylacetylene-4,4′-dicarboxylic acid or stilbene-x,x′-dicarboxylic acids. Among the cycloaliphatic dicarboxylic acids, mention may be made of cyclohexanedicarboxylic acids, in particular cyclohexane-1,4-dicarboxylic acid. Among the aliphatic dicarboxylic acids, the (C₃ to C₁₉) alkanediacids are particularly suitable, where the alkane moiety can be straight-chain or branched.

It is particularly advantageous that a copolyester based on terephthalate and on small quantities (<5 mol %) of isophthalate, or based on terephthalate and on small quantities (<5 mol %) 2,6-naphthalate is used in the baser layer (B). In this case the film has particularly good production properties and optical properties. The base layer (B) then in essence comprises a polyester copolymer mainly comprised of terephthalic acid and isophthalic acid units and of ethylene glycol units. The particularly preferred copolyesters that provide the desired properties of the film are those comprised of terephthalate units and isophthalate unit sand of ethylene glycol units.

The polyesters for the base layer (B) can by way of example be produced by the transesterification process. This proceeds from dicarboxylic esters and from diols, which are reacted with use of the usual transesterification catalysts, such as salts of zinc, of calcium, of lithium, of magnesium and of manganese. The intermediates are then polycondensed in the presence of well-known polycondensation catalysts, for example antimony trioxide or titanium, aluminum or germanium salts. Production can be achieved equally well by the direct esterification process in the presence of polycondensation catalysts. This proceeds directly from the dicarboxylic acids and the diols.

It has proven particularly advantageous to polycondense the intermediates in the presence of titanium dioxide or germanium compounds, or to carry out the direct esterification process in the presence of polycondensation catalysts such as titanium dioxide or germanium compounds. The polyester film is thus antimony-free. In the particularly preferred case, a desirable polyester film comprises no antimony and therefore can be used in packaging applications where the film has direct contact with food.

In order to achieve a further improvement of the processing behavior of the film in the present invention, it is advantageous that particles are also incorporated into the base layer (B) in the case of a two-layer film structure (AB), or into the non-sealable outer layer (C) in the case of a three-layer film structure (ABC), with compliance with the following conditions:
The median particle diameter d₅₀ of the particles should be 2 to 8 μm. It has proven to be particularly advantageous here to use particles with median particle diameter d₅₀ 2.5 to 7.5 μm and particularly preferably 3 to 7 μm.
The particles should be present at a concentration of up to 0.5% by weight. The concentration of the particles is preferably 0.01 to 0.4% by weight and particularly preferably 0.1 to 0.35% by weight.

In order to achieve the abovementioned properties, in particular the optical properties of the film, it has proven advantageous in particular in the case of a three-layer film with ABC structure to adjust the quantities of particles in the base layer (B) to be lower than in the outer layer (C). In the case of the three-layer film of the type mentioned, the quantity of the particles in the base layer (B) is advantageously to be between 0 and 0.2% by weight, preferably between 0 and 0.15% by weight, in particular between 0 and 0.1% by weight. It has proven particularly advantageous to incorporate, into the base layer, only particles that pass into the film by way of self-regrind (self-recyclate). The desired optical properties of the film, in particular the haze of the film, can thus be successfully achieved.

The thickness of the other, non-sealable outer layer (C) can be the same as that of the outer layer (A) or differ therefrom; its thickness is generally between 10 and 50 μm.

The base layer (B) can moreover additionally comprise conventional additives, for example stabilizers (UV, hydrolysis, heat) or other fillers (e.g. color pigments), in the concentrations recommended by the producer. These additives are advantageously added to the polymer or the polymer mixture before melting.

The base layer (B) additionally comprises regrind (film waste, for example trims or start-up material, or skeletal waste), a quantity of up to 60% by weight is introduced into the extrusion process during production of the film, without any resultant adverse effect on the physical, in particular the optical, properties of the film.

### Structure of the Film

The heat-sealable film of the invention can have two or three layers. A three-layer structure of the film with layers (ABC) has proven advantageous for achievement of the abovementioned properties, in particular the required optical properties. The film of the invention then comprises the base layer (B), the heat-sealable outer layer (A) on one of the sides of the base layer (B), and the outer layer (C) on the other side of the base layer (B).

### Thickness of the Film

The total thickness of the polyester film of the invention can vary within certain limits. It is 100 to 1500 μm, preferably 110 to 1300 μm and particularly preferably 120 to 1100 μm, where the thickness of the base layer accounts for at least 65%. If the thickness of the film is below 100 μm, the mechanical properties and the barrier properties of the film are inadequate. If the thickness of the film is above 1500 μm, the sealing time of the film becomes poorer and moreover production of the film becomes uneconomic; both are undesirable.

### Film Production Process

The invention also provides a process for the production of the thermoformable polyester film of the invention by the known coextrusion process. The procedure in the context of this process is that the melt corresponding to the individual layers (AB) and, if present (C) of the film are coextruded through a flat-film die, and the resultant film is drawn off on one or more rolls for solidification, and is then rolled up. The film is then cooled in the invention in a manner such that the film is in essence amorphous.

### Inventive Properties

The heat-sealable and thermoformable polyester film of the invention, produced by the process of the invention, has a number of properties, the most important of which are listed below.

The haze of the heat-sealable polyester film is below 10%. The haze of the polyester film is preferably below 9% and particularly preferably below 8%.

The clarity of the heat-sealable polyester film is above 80%. The clarity of the polyester film is preferably above 82% and particularly preferably above 84%.

The gloss of the heat-sealable polyester film is above 100, above 110 in the preferred embodiment and above 120 in the particularly preferred embodiment.

The transparency of the heat-sealable polyester film is above 89. The transparency is preferably above 90 and particularly preferably above 90.5.

The polyester film of the invention exhibits very good sealing properties. The seal seam strength of the outer layer (A) in relation to itself (FIN sealing) after sealing at 150° C. (460 N, 2 s) is above 3 N/15 mm and at most 10 N/15 mm.

A secure seal in relation to the lid film is achieved here in all cases, even when the outer layer (A) has been contaminated by way of example with meat juices.

The polyester film has excellent suitability for packing foods and other consumable products, in particular for the packaging of foods and other consumable products in trays, where heat-sealable polyester films are used for the closure of the packaging.

The polyester film also features very good winding behavior.

The film is particularly suitable for use for the production of packaging where seal seam strength between the outer layer (A) and a suitable lid film is in the range 3 to 10 N/15 mm.

Table 1 collates inter alia the most important inventive properties of the film.

TABLE 1

| | Range of the | | Particularly | | |
|---|---|---|---|---|---|
| Outer layer (A) | invention | Preferred | preferred | Unit | Test method |
| Proportion of units composed of aut auf | 25 to 95 | 40 to 90 | 50 to 88 | mol % | |
| aromatic dicarboxylic acids in polyester | | | | | |
| Proportion of units composed of | 5 to 75 | 10 to 60 | 12 to 50 | mol % | |
| aliphatic dicarboxylic acids in polyester | | | | | |
| Polyester I (aromatic) | 10 to 60 | 15 to 55 | 20 to 50 | % by wt. | |
| Polyester II (aliphatic-aromatic) | 20 to 70 | 25 to 65 | 30 to 60 | % by wt. | |
| Polyester III (aromatic) | 0 to 15 | 3 to 12 | 4 to 10 | % by wt. | |
| Anti-PET polymer | 0 to 10 | 3 to 10 | 5 to 10 | % by wt. | |
| d₅₀ particle diameter | 2 to 8 | 2.5 to 7.5 | 3.0 to 7 | μm | internal |
| Filler concentration | to 0.5 | 0.01 to 0.4 | 0.01 to 0.35 | % by wt. | internal |
| Thickness of outer layer (A) | 10 to 100 | | | μm | internal |

Film properties

| | | | | | |
|---|---|---|---|---|---|
| Thickness of film | 100 to 1500 | 110 to 1300 | 120 to 1100 | μm | |
| FIN sealing (150° C., 460N, 2 s) | 3 to 10 | 3.2 to 10 | 3.5 to 10 | N/15 mm | internal |
| Haze of film | <10 | <9 | <8 | % | ASTM D1003-52 |
| Clarity of film | >=80 | >=82 | >=84 | % | ASTM D1003-51 |
| Gloss of film | >100 | >110 | >120 | | DIN 67530 |

### Definitions

The expression “heat-sealable” means in general terms the property possessed by a multilayer polyester film comprising at least one base layer (B) and comprising at least one heat-sealable outer layer (A). The heat-sealable outer layer (A) is bonded to a substrate made of thermoplastic, for example trays made of a-PET, by means of sealing jaws through application of heat (e.g. 110 to 220° C.) and pressure/compressive force (I to 6 bar or 200 to 1000 N) within a defined period (0.1 to 4 sec); the base layer (B) does not itself develop plasticity during this procedure. This is achieved in that the polymer of the outer layer (A) generally has a significantly lower melting or softening point than the polymer of the base player. If, by way of example, polyethylene terephthalate with melting point 254° C. (c-PET) is used as polymer for the base layer, the melting point of the heat-sealable outer layer (A) is generally significantly below 200° C.

The following test methods were used to characterize the raw materials and the films for the purposes of the present invention.

### Test Methods

### Haze, Clarity and Transparency

A HAZE-GARD® XL-211 haze meter from BYK Gardner was used to test the polyester films. Haze was determined in accordance with ASTM D1003-61, method A. Clarity is measured in accordance with ASTM D1003 by using a HAZE-GARD®, but now using the “clarity port” of the tester. Transparency is measured in accordance with ASTM D1033-61, method A. All of the tests on the film were carried out directly after production.

### 20° Gloss

Gloss is determined in accordance with DIN 67530. The reflectance value is measured as optical variable representing the surface of a film. Using a method based on the standards ASTM D523-78 and ISO 2813, the angle of incidence is set to 20°. A light beam impacts the flat test surface at the set angle of incidence and is reflected or scattered thereby. Light impacting the photoelectronic detector is indicated in the form of a proportional electrical variable. The value measured is dimensionless, and must be stated together with the angle of incidence.

### Standard Viscosity SV

Standard viscosity in dilute solution SV was measured by a method based on DIN 53 728 part 3 in an Ubbelohde viscometer at (25±0.05) ° C. Dichloroacetic acid (DCA) was used as solvent. The concentration of the dissolved polymer with 1 g of polymer/100 mL of pure solvent. Dissolution of the polymer took 1 hour at 60° C. If the samples had not dissolved completely after this time, up to two further dissolution attempts were carried out at 80° C. in each case for 40 min, and the solutions were then centrifuged for 1 hour at a rotation rate of 4100 min⁻¹.

The dimensionless SV value is determined as follows form the relative viscosity (ηᵣₑₗ=η/ηₛ):

SV=(ηᵣₑₗ−1)×1000

The proportion of particles in the film or polymer raw material was determined by ashing and corrected by increasing input weight accordingly, i.e.:

$$input weight = \frac{( input weight corresponding to 100 \% of polymer )}{[ ( 100 - particle content in \% by weight ) \cdot 0.01 ]}$$

### Median Particle Diameter d₅₀

Median diameter d₅₀ is determined by using a Malvern MASTERSIZER® 2000 on the particle to be used. For this, the samples are placed in a cell with water, and the cell is then placed in the tester. A laser is used to analyze the dispersion, and the particle size is determined from the signal via comparison with a calibration curve. The particle size distribution is characterized by two parameters, the median value d₅₀ (=measure of position of the central value) and of the degree of scattering, the value known as SPAN98 (=measure of scattering of the particle diameter). The test procedure is automatic, and also includes mathematical determination of the d₅₀ value. The d₅₀ value is defined here as being determined from the (relative) cumulative particle size distribution curve: the point of intersection of the 50% ordinate value with the cumulative curve provides the desired d₅₀ value on the abscissa axis.

Measurements on the film produced by using these particles give a d₅₀ value that is lower by from 15 to 25% than that of the particles used.

### Seal Seam Strength (DIN 55529)

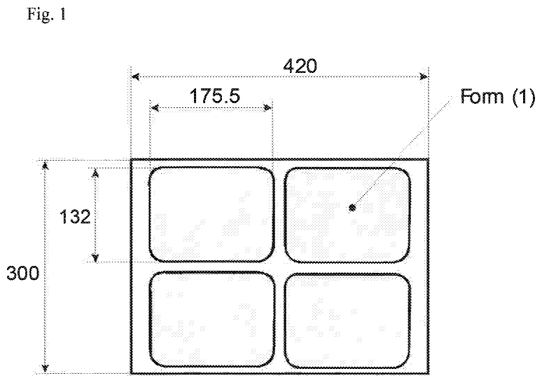

For reasons of measurement accuracy and feasibility, FIN seal seam strength was tested on film strips of width 15 mm cut from the side walls of a thermoformed tray, rather than directly on the film of the invention with the sealable layer (A). The thermoformable polyester film was clamped into a Multivac machine (R 245/SN:166619) and thermoformed under the following conditions: (mold temperatures 150° C., heating time 2-3 s, explosive forming/compressed-air reservoir 2 bar, mold pressure 2 bar, molding time: 2 s). FIG. 1 shows the tray formats. Draw depth was 70 mm.

FIN seal seam strength was measured in accordance with DIN 55529 (2005-09). Two film strips of width 15 mm were cut from the side walls of a thermoformed tray (see above for production process), the sealable layers (A) were mutually superposed and pressed together at 150° C. for a period of 2 s with “sealing pressure” 460 N (equipment: Brugger NDS, single-side-heated sealing jaw). In order to avoid sticking on the sealing jaw, a crystalline polyester film of thickness 12 μm was placed between the film of the invention and the sealing jaw. Seal seam strength (maximal force) was determined with peel angle 90° (90° peel method) at velocity 200 mm/min.

### Inventive Example 1

### I Production of Thermoformable Polyester Film

The following starting materials were used for the respective coextruded layers (ABC) to produce the thermoformable and heat-sealable polyester film:

Outer layer (A), mixture of

| | |
|---|---|
| 60.0% by weight | of polyester I (copolymer of 78 mol % |
| | of ethylene terephthalate, 22 mol % of |
| | ethylene isophthalate) with SV value |
| | 850. The T_{g} of polyester I is about |
| | 75° C. |
| 40% by weight | of polyester II (=copolymer |
| | comprising 40 mol % of ethylene |
| | sebacate, 60 mol % of ethylene |
| | terephthalate) with SV value 1100. The |
| | T_{g} of polyester II is about −2° C. |

Base layer (B)

| | |
|---|---|
| 100% by weight | of copolyester comprised of 95 mol % |
| | of terephthalate units and 5 mol % of |
| | isophthalate units and of 100 mol % of |
| | ethylene glycol units, with SV value |
| | 800. |

Outer layer (C)

| | |
|---|---|
| 95% by weight | of copolyester comprised of 95 mol % |
| | of terephthalate units and 5 mol % of |
| | isophthalate units and of 100 mol % of |
| | ethylene glycol units, with SV value |
| | 800. |
| 5% by weight | of 98.5% by weight of polyethylene |
| | terephthalate and 1.5% by weight of |
| | SYLOBLOC ® 46 silica. |
| Thickness of film | 300 μm |
| Thickness of outer layer (A) | 50 μm |

The abovementioned raw materials were melted in a respective extruder per layer, and extruded through a three-layer flat-film die with ABC layer structure onto a chilled take-offroll. The resultant amorphous film was edge-trimmed and then rolled up.

The production conditions in the individual steps were:

| | | | |
|---|---|---|---|
| Extrusion | Melt temperatures (ABC) | 270 | ° C. |
| | Take-off roll temperature | 20 | ° C. |
| | Residence time of film on take-off roll | 15 | s |

Table 2 presents the composition of the film, and also further information relating to the film of the invention, in particular relating to the properties of the film of the invention.

### II Heat-Sealable Lid Film

The heat-sealable lid film was produced by repeating example 3 of EP 1 138 480 B1.

### III Production of Packaging

The thermoformable polyester film and the heat-sealable lid film were respectively separately clamped into a Multivac machine (R 245/SN:166619). The thermoformable polyester film was thermoformed under the following conditions: (mold temperatures 150° C., heating time 2-3 s, explosive forming/compressed-air reservoir 2 bar, mold pressure 2 bar, molding time: 2 s). FIG. 1 shows the tray formats. Draw depth was 70 mm.

The mold was cooled, and the thermoformed film was ejected from the mold. Portions of pork (about 1000 g) were placed into the cavity, and the lid film was applied to the upper side of the tray. The manner of application of the lid film to the tray here was such that the heat-sealable surface (A′) of the upper film was in contact with the portion of meat and with the sealable area of the tray. Heat-sealing was carried out in the same machine at a temperature of 160° C. for 2 s with a pressure of 2 bar. The seal was secure and durable.

### Inventive Example 2

The only change made from inventive example 1 for the production of the thermoformable and sealable polyester film was the formulation of the outer layer (A); all other parameters remained unchanged.

Outer layer (A), mixture of

| | |
|---|---|
| 40.0% by weight | of polyester I (copolymer of 78 mol % |
| | of ethylene terephthalate, 22 mol % of |
| | ethylene isophthalate) with SV value |
| | 850. The T_{g} of polyester I is about |
| | 75° C. |
| 60% by weight | of polyester II (=copolymer |
| | comprising 40 mol % of ethylene |
| | sebacate, 60 mol % of ethylene |
| | terephthalate) with SV value 1000. The |
| | T_{g} of polyester II is about −2° C. |

### Inventive Example 3

The only change made from inventive example 1 for the production of the thermoformable and sealable polyester film was the formulation of the outer layer (A); all other parameters remained unchanged.

Outer layer (A), mixture of

| | |
|---|---|
| 46% by weight | of polyester I (copolymer of 67 mol % |
| | of ethylene terephthalate, 33 mol % of |
| | ethylene isophthalate) with SV value |
| | 850. The T_{g} of polyester I is about |
| | 75° C. |
| 49% by weight | of polyester II (=copolymer |
| | comprising 40 mol % of ethylene |
| | sebacate, 60 mol % of ethylene |
| | terephthalate) with SV value 1000. The |
| | T_{g} of polyester II is about −2° C. |
| 5.0% by weight | of polyester III (copolymer of 89 mol % |
| | of ethylene terephthalate, 11 mol % of |
| | ethylene isophthalate) with SV value |
| | 850 and 15% by weight of |
| | SYLOBLOC ® 43 silica with d₅₀ |
| | 3.9 μm. The Tg of polyester III is about |
| | 75° C. |

### Comparative Example 1

Unlike in inventive example 1, a standard polyester (=a-PET) equipped with an antiblocking agent was selected to produce the thermoformable polyester film. In all other aspects (e.g. process, production of pack) there is no difference from inventive example 1.

Film structure

| | |
|---|---|
| 95% by weight | of polyethylene terephthalate |
| 5% by weight | of 85% by weight of polyethylene |
| | terephthalate and 15% by weight of |
| | SYLOBLOC ® 43 silica |
| Thickness of film | 300 μm |

The pack is not suitable for sealing through contamination.

TABLE 2
Thermoformable film

| | | | | | | | | | | | | | Glass |
|---|---|---|---|---|---|---|---|---|---|---|---|---|---|
| | | | | | | | | | | | | | transition |
| | | | | | | | | | | | | Ratios of | temperatures |
| | Composition | | | | | | | Composition of | | | | PI/PI/PII to | of PI/PI/PII |
| | of polyester I | | | Composition of | | | | polyester III | | | Anti-PET | anti-PET | and anti-PET |
| | TA | IA | EG | polyester II | | | | TA | IA | EG | polymer | polymer | polymer |
| | mol % | | | SeS | TA | IA | EG | mol % | | | COC | % by weight | ° C. |
| Inv. ex. 1 | 78 | 22 | 100 | 40 | 60 | | 100 | | | | 100 | 60/40/0/0 | 75/−2/—/— |
| | 78 | 22 | 100 | 40 | 60 | | 100 | | | | 100 | 40/60/0/0 | 75/−2/—/— |
| | 67 | 33 | 100 | 40 | 60 | | 100 | 89 | 11 | 100 | 100 | 46/49/5/0 | 75/−2/75/— |
| Comp. | 100 | | 100 | | | | | | | | 100 | 100/0/0/0 | 75/—/—/— |
| ex. 1 | | | | | | | | | | | | | |

| | | | Outer-layer | | Antiblocking | | FIN seal | | |
|---|---|---|---|---|---|---|---|---|---|
| | | Film | thicknesses | | agent | | seam | | |
| | Film | thickness | (A) | (C) | Diameter | Concentration | strength | Haze | |
| | structure | μm | μm | | μm | % | 150° C. | % | Gloss |
| Inv. ex. 1 | ABC | 300 | 50 | 20 | | | 7 | 6 | 127 |
| | ABC | 300 | 50 | 20 | | | 6 | 7 | 121 |
| | ABC | 300 | 50 | 20 | 3.9 | 0.075 | 5.5 | 9 | 118 |
| Comp. | ABC | 300 | | | 3.9 | 0.075 | 2.5 | 11 | 95 |
| ex. 1 | | | | | | | | | |

TA terephthalate,
IA isophthalate,
EG ethylene glycol
SeS sebacate

That which is claimed:

1. A coextruded, unstructured, transparent and thermoformable polyester film comprising at least one base layer (B) made of a-PET and one heat-sealable outer layer (A), where the heat-sealable outer layer (A) comprises at least 80% by weight of polyester,
a) the polyester of the outer layer (A) is comprised of 25 to 95 mol % of units derived from at least one aromatic dicarboxylic acid and 5 to 75 mol % of units derived from at least one aliphatic dicarboxylic acid, and is based on aliphatic diols, where the mol % data always give a total of 100%
b) the outer layer (A) comprises up to 0.4% by weight of inorganic or organic particles with median diameter d₅₀ 2.0 to 8.0 μm,
c) the outer layer (A) has a thickness of 10 to 100 μm, and
d) the film has a thickness in the range 100 to 1500 μm.

2. The polyester film as claimed in claim 1, wherein the film has a haze of below 10% and the film has a clarity of at least 80%.

3. The polyester film as claimed in claim 1, wherein the film has a seal seam strength in relation to itself, or FIN sealing, in the range 3 to 10 N/15 mm.

4. The polyester film as claimed in claim 1, wherein the aromatic dicarboxylic acid is selected from one or more elements from the group consisting of terephthalic acid, isophthalic acid, phthalic acid and naphthalene-2,6-dicarboxylic acid.

5. The polyester film as claimed in claim 1, where the aliphatic dicarboxylic acid is selected from one or more elements from the group consisting of succinic acid, glutaric acid, adipic acid, pimelic acid, suberic acid, azeleic acid and sebacic acid.

6. The polyester film as claimed in claim 5, where the aliphatic dicarboxylic acid is selected from one or more elements from the group consisting of adipic acid and sebacic acid.

7. The polyester film as claimed in claim 1, where the aliphatic diol is selected from one or more elements from the group consisting of ethylene glycol, 1,3-propanediol, 1,3-butanediol, 1,4-butanediol, 1,5-pentanediol, 2,2-dimethyl-1,3-propanediol, diethylene glycol, triethylene glycol, 1,4-cyclohexanedimethanol and neopentyl glycol.

8. The polyester film as claimed in claim 1, wherein the polyester includes the following dicarboxylate moieties and alkylene moieties, based in each case on the total quantity of dicarboxylate and, respectively, total quantity of alkylene:
25 to 95 mol % of terephthalate,
0 to 25 mol % of isophthalate,
5 to 75 mol % of sebacate,
0 to 50 mol % of adipate,
more than 30 mol % of ethylene or butylene.

9. The polyester film as claimed in claim 8, wherein the polyester includes:
30 to 90 mol % of terephthalate,
5 to 20 mol % of isophthalate,
8 to 70 mol % of sebacate,
0 to 40 mol % of adipate,
more than 40 mol % of ethylene or butylene.

10. The polyester film as claimed in claim 9, wherein the polyester includes:
40 to 70 mol % of terephthalate,
10 to 20 mol % of isophthalate,
11 to 65 mol % of sebacate,
0 to 30 mol % of adipate,
more than 50 mol % of ethylene or butylene.

11. The polyester film as claimed in claim 1, where the outer layer (A) comprises up to 10% by weight of a polymer that is incompatible with polyester.

12. The polyester film as claimed in claim 11, where the polymer that in incompatible with polyester comprises one or more polymers based on ethylene, on propylene, on cycloolefins, on amides or styrene.

13. The polyester film as claimed in claim 12, wherein the polymer based on ethylene is linear low density polyethylene or high density polyethylene.

14. The polyester film as claimed in claim 1, wherein the film is comprised of three layers and has a base layer (B), a heat-sealable outer layer (A) on one of the side of the base layer (B) and an outer layer (C) on the other side of the base layer (B).

15. A process for the production of the polyester film as claimed in claim 1 comprising melting polymers for individual layers (A) and (B) or (A), (B) and (C) in separate extruders,
coextruding the corresponding melts through a flat-film die, and
drawing off the resultant coextruded film for solidification on one or more rolls and
rolling up the solidified film.

16. The process as claimed in claim 15, wherein the polyester for the layer (A) is a mixture of two polyesters I and II, said process further comprising introducing the mixture of polyesters into the extruder for the layer (A).

17. The process as claimed in claim 15, wherein the polyester for the outer layer (A) is a mixture of three polyesters I, II and III, said process further comprising introducing the mixture of polyesters into the extruder for the layer (A).

18. The process as claimed in claim 17, wherein the polyester I is based on the following dicarboxylate moieties and alkylene moieties, based in each case on the total quantity of dicarboxylate and, respectively, total quantity of alkylene:
60 to 100 mol % of terephthalate;
0 to 40 mol % of isophthalate;
more than 50 mol % of ethylene units;
the polyester II is based on the following dicarboxylate moieties and alkylene moieties, based in each case on the total quantity of dicarboxylate and, respectively, total quantity of alkylene:
20 to 70 mol % of sebacate;
0 to 50 mol % of adipate;
10 to 80 mol % of terephthalate;
0 to 30 mol % of isophthalate;
more than 30 mol % of ethylene or butylene;
and the polyester III is based on the following dicarboxylate moieties and alkylene moieties, based in each case on the total quantity of dicarboxylate and, respectively, total quantity of alkylene:
80 to 98 mol % of terephthalate;
2 to 20 mol % of isophthalate;
more than 50 mol % of ethylene units.

19. The process as claimed in claim 18, wherein the polyester I is based on the following dicarboxylate moieties and alkylene moieties:
62 to 95 mol % of terephthalate;
5 to 38 mol % of isophthalate;
more than 65 mol % of ethylene units;
and the polyester II is based on the following dicarboxylate moieties and alkylene moieties:
30 to 65 mol % of sebacate;
0 to 45 mol % of adipate;
20 to 70 mol % of terephthalate;
3 to 25 mol % of isophthalate;
more than 40 mol % of ethylene or butylene;
and the polyester III is based on the following dicarboxylate moieties and alkylene moieties:
82 to 96 mol % of terephthalate;
4 to 18 mol % of isophthalate;
more than 65 mol % of ethylene units.

20. The process as claimed in claim 19, wherein the polyester I is based on the following dicarboxylate moieties and alkylene moieties:
66 to 93 mol % of terephthalate;
7 to 34 mol % of isophthalate;
more than 80 mol % of ethylene units;
and the polyester II is based on the following dicarboxylate moieties and alkylene moieties:
35 to 60 mol %, of sebacate;
0 to 40 mol % of adipate;
30 to 60 mol % of terephthalate;
5 to 20 mol % of isophthalate;
more than 50 mol % of ethylene or butylene;
and the polyester III is based on the following dicarboxylate moieties and alkylene moieties:
74 to 95 mol % of terephthalate;
5 to 17 mol % of isophthalate;
more than 80 mol % of ethylene units.

21. The process as claimed in claim 17, where polyester I is present in the outer layer (A) in a proportion of 10 to 60% by weight and the polyester II is present in a proportion of 20 to 70% by weight and the polyester III is present in a proportion of 0 to 15% by weight.

22. A packaging for foods or other consumable products comprising the polyester film as claimed in claim 1.

23. The packaging as claimed in claim 22, wherein the packaging for foods or other consumable products is a tray.
